(19) United States
(12) Patent Application Publication
(10) Pub. No.: US 2005/0240016 A1
(43) Pub. Date: Oct. 27, 2005

(54) Process for the production of methylhydroxyalkyl cellulose

(75) Inventors: Hartwig Schlesiger, Bad Fallingbostel (DE); Wolfgang Dannhorn, Soltau (DE); Erik-Andreas Klohr, Walsrode (DE); Martin Kowollik, Bad Fallingbostel (DE); Marc Oliver Schmidt, Walsrode (DE)

Correspondence Address: BAYER MATERIAL SCIENCE LLC, 100 BAYER ROAD, PITTSBURGH, PA, 15205, US

(73) Assignee: Wolff Cellulosics GmbH & Co. KG

(21) Appl. No.: 11/105,679

(22) Filed: Apr. 14, 2005

(30) Foreign Application Priority Data
Apr. 21, 2004 (DE) 102004019296.0

(51) Int. Cl. C08B 11/02

(52) U.S. Cl. 536/99

(57) ABSTRACT

A process of producing methylhydroxyalkyl cellulose (MHAC) is described and involves in a first step (a), (i) introducing cellulose and a suspension medium into an autoclave, the suspension medium comprising 20 wt. % to 50 wt. % of chloromethane, based on the total weight of the said suspension medium, and (ii) spraying the cellulose in the autoclave with an aqueous alkali metal hydroxide solution, thereby alkalizing the cellulose and reacting the cellulose with chloromethane. In a second step (b), hydroxyalkylating agent is optionally introduced into the autoclave at a temperature above 60° C. In a third step (c) alkali metal hydroxide is introduced into the autoclave in a hyperstoichiometric quantity of at least +0.1 mol eq., relative to the chloromethane utilised. In a fourth step (d), at least one hydroxyalkylating agent is optionally introduced into the autoclave at a temperature above 60° C., and the introduced hydroxyalkylating agent is allowed to react for at least 20 min. In a fifth step (e), additional chloromethane is introduced into the autoclave in a hyperstoichiometric quantity of at least +0.2 mol eq., relative to the total alkali metal hydroxide utilised up to this point. In a sixth step (f), additional alkali metal hydroxide is optionally introduced into the autoclave, and the reaction is allowed to continue at a temperature of from 60° C. to 110° C. Finally, the suspension medium is removed by means of distillation, thus forming a distillate comprising residual chloromethane, and the methylhydroxyalkyl cellulose is isolated. Optionally, the isolated methylhydroxyalkyl cellulose may be washed, and dried. The addition of hydroxyalkylating agent occurs in step (b) and/or step (d).

### CROSS REFERENCE TO RELATED PATENT APPLICATION

The present patent application claims the right of priority under 35 U.S.C. §119 (a)-(d) of German Patent Application No. 102004019296.0, filed Apr. 21, 2005.

### FIELD OF THE INVENTION

The invention described here relates to a process for the industrial production of methylhydroxyalkyl celluloses (MHACs), preferably methylhydroxyethyl cellulose (MHEC) and methylhydroxypropyl cellulose (MHPC).

### BACKGROUD OF THE INVENTION

It is known that methyl cellulose and named mixed ethers thereof are produced in a multi-stage process. In the first stage the cellulose utilised is ground to a desired particle size spectrum. In the second stage the ground cellulose is mixed intimately in a mixer with a concentrated aqueous solution of an alkali metal hydroxide, in particular sodium hydroxide, and activated to give the alkali cellulose.

The known processes are spray alkalisation in a suitable mixing unit, during which the ground cellulose is sprayed with alkali metal solution. In the slurry process the ground cellulose is suspended in a suspension medium (non-solvent), and the alkali is then added. In the mash alkalising process the cellulose is suspended in caustic soda solution and is then passed through screw presses or perforated cylinder presses.

In the third stage the heterogeneous reaction with chloromethane and the hydroxyalkylating agents such as ethylene oxide and/or propylene oxide takes place.

The further process stages encompass purification of the cellulose ethers, grinding and drying.

There is a difficulty in producing MC and MHAC industrially, in that the alkalisation, but in particular the etherification with chloromethane, ethylene oxide and propylene oxide are exothermic reaction stages involving considerable evolution of heat. Now if dimethyl ether and/or chloromethane is/are used as a suspension medium (slurry) in the slurry process, the temperature rise is associated with a simultaneous pressure increase.

Furthermore, MC and MHAC must be producible with different degrees of substitution in order to be able to provide products for very widely varying fields of application.

In cellulose ether chemistry, the alkyl substitution is generally described by the DS. The DS is the average number of substituted OH groups per anhydroglucose unit. The methyl substitution is, for example, indicated as the DS (methyl), or DS (M).

Hydroxyalkyl substitution is conventionally described by the MS. The MS is the average number of moles of the etherifying reagent which are bound in an ether linkage, per mole anhydroglucose unit. Etherification with the etherifying reagent ethylene oxide is, for example, indicated as the MS (hydroxyethyl), or MS (HE). Etherification with the etherifying reagent propylene oxide is accordingly indicated as the MS (hydroxypropyl), or MS (HP).

The side groups are determined on the basis of the Zeisel method (literature: G. Bartelmus and R. Ketterer, Z. Anal. Chem. 286 (1977) 161-190).

Various properties of the products, such as, for example, the thermal flocculation point, solubility, viscosity, film-forming capacity, water retention capacity and adhesive strength, are adjusted by way of the degree of etherification and the type of substituents. MC and MHAC are utilised in different fields of application, for example as consistency regulators and processing aids in mineral and dispersion-based construction material systems, or in the preparation of cosmetics and pharmaceutical preparations. Cellulose ethers having high degrees of substitution are also suitable as thickeners for organic solvents.

Houben-Weyl, Methoden der Organischen Chemie [Organic Chemistry Methods], Makromolekulare Stoffe [Macromolecular Materials], 4^{th} edition, Vol. E 20, p. 2042 (1987), for example, provides an overview of the underlying chemistry and the production principles (production processes and process steps), as well as a summary of substances and a description of the properties and potential applications of the various derivatives.

In the production of MC and MHAC a molar excess of chloromethane to alkali metal hydroxide at the end of the etherification results in a faster reaction speed and consequently shorter reaction times than when reagent is utilised in exactly stoichiometric quantities. A molar chloromethane excess is therefore desirable at the end of the reaction.

However, it is disadvantageous here that this excess quantity of chloromethane is mixed with the inert suspending agent. This mixture must be either separated, discarded and disposed of, or re-utilised.

Separation of the substance mixture would be associated with additional capital and energy expenditure and consequently additional cost. Disposal would lead to elevated utilisation of reagents per reaction batch and consequently to additional cost.

Re-utilisation of this substance mixture is possible, however it is then no longer possible to adhere to the advantageous molar ratios in respect of reagents, as described, for example, in EP-A-1 180 526.

Patent Application No. WO 00/59947 describes a process for the production of methyl cellulose and methyl cellulose derivatives having elevated “gel strength”, which is characterised in that, in a first step, cellulose is reacted with an initial quantity of aqueous alkali metal hydroxide and an initial quantity of methylating agent, and the cellulose which has been etherified in the first step is reacted in a second step with a second quantity of aqueous alkali metal hydroxide and a second quantity of methylating agent.

Unfortunately, no information is provided as to the ratios of aqueous alkali metal hydroxide to methylating agent which should advantageously be utilised. It emerges from the text that the alkali metal hydroxide is charged before the methylating agent because the rate of addition of the aqueous alkali is not critical, whereas the rate of addition of the methylating agent is defined.

The procedure of WO 00/59947 is a genuine two-stage process which is distinguished by the steps alkalisation, methylation, alkalisation, methylation.

This procedure is also confirmed by the Examples described in WO 00/59947.

A comparable two-stage process for the production of methyl cellulose is described in DE-A 1060374. Methyl cellulose is produced from alkali cellulose by the action of chloromethane, is then immediately re-alkalised and is further etherified with excess chloromethane.

U.S. Pat. No. 4,456,751 and U.S. Pat. No. 4,477,657 describe processes in which the alkali cellulose is first reacted with an alkylene oxide, then with an alkyl halide and optionally again with an alkyl halide. In this process no chloromethane or inert solvent is present as a slurry in the first reaction phase.

EP-A-1279680 and EP-A-1180526 describe processes for the production of alkylhydroxyalkyl cellulose with an optimised addition sequence of the required reagents. In the processes described here, high reagent yields, in particular with reference to the alkylene oxides, are realised as a result of utilising greatly reduced quantities of alkyl chloride in the first reaction phase. This is achieved either by a low alkyl chloride concentration in the slurry or by utilising a low quantity of slurry. Both are unfavourable for industrial production, because in one case no recycled slurry mixture can be utilised and in the other case, the slurry quantity necessary for adequate heat removal is insufficient. The processes described here consequently cannot be used for highly substituted MHACs in industrial production plant.

### SUMMARY OF THE INVENTION

The object of the invention described hereinbelow was to provide an industrial process for the production of methylhydroxyalkyl cellulose derivatives such as, for example, methylhydroxyethyl cellulose and methylhydroxypropyl cellulose, which permits a large quantity of suspension medium (slurry) to be utilised in the first reaction phase, additionally makes possible a high stoichiometric excess of chloromethane relative to the alkali metal hydroxide utilised in the last etherification step, and permits the exhaust gas from one batch to be fed into the next batch without additional exhaust gas working-up steps, and hereby delivers good reagent yields of the educts utilised.

In a process which operates batch-wise, depending on the degree of substitution sought different quantities of alkali metal hydroxide (as an aqueous solution), chloromethane and hydroxyalkylation reagents such as, for example, ethylene oxide and propylene oxide, are reacted with the cellulose to obtain an MC or MHAC.

For this purpose the following steps are generally followed

charging of the reactor with cellulose

inertising the cellulose

addition of a suspending agent

spraying of the cellulose with caustic solution (alkalisation)

etherification of the cellulose at elevated temperature (above 40° C.)

spraying-on of reagents

distillation of volatile substances (batch exhaust gas)

discharge of the raw cellulose ether to washing (optionally after the addition of hot washing water)

Examples of suitable reactors for such processes are reactors of the Druvatherm DVT type from Lödige. These reactors have a volume of at least 10 m³ for industrial production plant. Even larger reactors are preferably utilised.

In particular, the invention relates to a process for the industrial production of methylhydroxyalkyl cellulose (MHAC) from cellulose in the presence of alkali with chloromethane and hydroxyalkylating agent, wherein the process comprises:

(a)
(i) introducing cellulose and a suspension medium (also referred to herein as a “suspending agent”) into an autoclave, said suspension medium comprising 20 wt. % to 50 wt. % of chloromethane, based on the total weight of the said suspension medium, and
(ii) spraying the cellulose in said autoclave with an aqueous alkali metal hydroxide solution, thereby alkalizing the cellulose and reacting the cellulose with chloromethane;

(b) optionally introducing at least one hydroxyalkylating agent into said autoclave at a temperature above 60° C.;

(c) introducing alkali metal hydroxide into said autoclave in a hyperstoichiometric quantity of at least +0.1 mol eq., in relation to the chloromethane utilised (introduced into the autoclave in step (a));

(d) optionally introducing at least one hydroxyalkylating agent into said autoclave at a temperature above 60° C., and allowing the introduced hydroxyalkylating agent to react for at least 20 min;

(e) introducing chloromethane into said autoclave in a hyperstoichiometric quantity of at least +0.2 mol eq., in relation to the total alkali metal hydroxide utilised (the total amount of alkali metal hydroxide introduced into the autoclave in steps (a) and (c));

(f) optionally introducing alkali metal hydroxide into said autoclave, and allowing reaction to continue at a temperature of from 60° C. to 110° C.; and

(g)
(i) removing said suspension medium (from the autoclave) by distillation, thereby forming a distillate comprising residual chloromethane,
(ii) isolating the methylhydroxyalkyl cellulose (produced by the process), and
(iii) optionally washing, and drying the isolated methylhydroxyalkyl cellulose
   wherein the hydroxyalkylating agent of step (d) is the same or different than the hydroxyalkylating agent of step (b), the alkali metal hydroxide is selected independently for each of steps (a), (c) and (f), and provided that addition of hydroxyalkylating agent occurs in step (b) and/or step (d).

The alkali metal hydroxide addition in step (a), (c) or (f) can take place in partial steps. The addition of one or more hydroxyalkylating agents takes place in step (b) and/or (d).

Other than in the examples, or where otherwise indicated, all numbers or expressions, such a those expressing structural dimensions, etc, used in the specification and claims are to be under stood as modified in all instances by the term “about.”

### DETAILED DESCRIPTION OF THE INVENTION

The process according to the invention serves for the production of binary, ternary and quaternary methylhydroxyalkyl celluloses (MHACs), preferably for the production of the binary derivatives methylhydroxyethyl cellulose (MHEC) and methyl hydroxypropylcellulose (MHPC), particularly preferably for the production of methyl hydroxypropylcellulose.

Dimethyl ether (DME), or preferably a mixture of DME and chloromethane, is utilised as an inert suspending agent.

The alkalisation of the cellulose takes place with inorganic bases, preferably with alkali metal hydroxides in aqueous solution, such as sodium hydroxide and potassium hydroxide, preferably with 35 to 60% caustic soda solution, particularly preferably with 48 to 52% caustic soda solution.

The actual cellulose etherification step at elevated temperature takes 1.5 to 6 hours, dependent on the desired degree of substitution.

Before, during or after the alkalisation, suspending agent, for example consisting of DME and chloromethane (MeCl), is added to the mixture. The suspending agent consists of at least 25 wt. % MeCl, in relation to the total weight of suspending agent, when a DME/MCl mixture is utilised. The suspending agent preferably consists of at least 30 wt. %, in particular at least 35 wt. % MeCl, in relation to the total weight. However, the suspending agent preferably consists of not more than 50 wt. % MeCl.

The quantity of suspending agent is from 1.0 to 5.0 parts per part cellulose. Parts here are to be understood as parts by weight. Preferably from 1.5 to 4.0 parts suspending agent, particularly preferably 2 to 3.5 parts suspending agent, are utilised per part cellulose.

The suspending agent is recycled exhaust gas from a previous batch. The suspending agent can optionally be enriched as to the MeCl content with further MeCl.

In step a) the reaction of alkali cellulose with chloromethane is carried out. The chloromethane comes in whole or in part from the suspending agent. The chloromethane quantity (MeCl I) is utilised in a molar excess in relation to the quantity of alkali metal hydroxide utilised (NaOH I).

The preferred quantity of chloromethane to be utilised is calculated in accordance with: mol eq NaOH I+0.2 to mol eq NaOH I+3.0. The particularly preferred quantity of chloromethane to be utilised is calculated in accordance with: mol eq NaOH I+0.3 to mol eq NaOH I+2.0. The most preferred quantity of chloromethane to be utilised is calculated in accordance with: mol eq NaOH I+0.4 to mol eq NaOH I+1.0.

For example, in case that a quantity of alkali metal hydroxide (NaOH I) of 2.3 mol eq. (per AGU) is employed in step a), the preferred quantity of chloromethane (MeCl I) is from 2.5 to 5.3 mol eq. (per AGU).

Suitable hydroxyalkylating agents for the introduction of hydroxyalkyl groups are, for example, ethylene oxide (EO), propylene oxide (PO), butylene oxide (BO).

Propylene oxide and ethylene oxide are particularly preferred. A plurality of hydroxyalkylating agents can also be utilised in one batch for the production of ternary methyl cellulose derivatives such as, for example, methylhydroxyethylhydroxybutyl cellulose.

The practical implementation of the process normally starts with inertised ground or shredded cellulose.

The alkalisation of the cellulose which is utilised in step c) takes place with from 0.8 to 4.0 eq alkali metal hydroxide per AGU, preferably with 1.1 to 2.7 eq alkali metal hydroxide per AGU, particularly preferably with 1.4 to 2.5 eq NaOH per AGU. Generally, the alkalisation is carried out at temperatures of from 15 to 50° C., preferably around 40° C., and for from 20 to 80 minutes, preferably for 30 to 60 minutes. Preferably, the NaOH is utilised in the form of a 35 to 60 wt. % aqueous solution, particularly preferably as a 48 to 52 wt. % caustic soda solution.

In step c) the dispensing-in of alkali metal hydroxide (NaOH II) takes place in at least the quantity which adjusts a hyperstoichiometric ratio of alkali metal hydroxide (at least mol eq MeCl+0.1) to methyl chloride (MeCl I). The preferred quantity of NaOH to be utilised adjusts a hyperstoichiometric ratio of mol eq MeCl+0.2 to +4.5. The particularly preferred quantity of NaOH to be utilised adjusts a hyperstoichiometric ratio of mol eq MeCl+0.4 to +2.5. The dispensing-in of the alkali metal hydroxide takes place as an aqueous solution at reaction temperature. No differentiation is consequently possible between the addition and the reaction phase. The dispensing-in of the alkali metal hydroxide in step c) can take place in one or more steps. Preferably, NaOH is utilised in the form of a 35 to 60 wt. % solution, particularly preferably as a 48 to 52% caustic soda solution.

The rate of addition of the alkali metal hydroxide in step c) and f) takes place at reaction temperature. The rate of addition of the alkali metal hydroxide is from 0.01 to 0.4 mol eq per minute. The rate of addition of the sodium hydroxide is preferably from 0.02 to 0.2 mol eq per minute. The rate of addition of the sodium hydroxide is particularly preferably from 0.04 to 0.1 mol eq per minute.

Optionally, the addition and reaction in step b) or between step c) and e) (designated as step d)) of one or more hydroxyalkylating agents takes place at reaction temperature. It is also possible both during step b) and additionally between step c) and e) to add one or more hydroxyalkylating agents at reaction temperature.

Preferably alkylene oxide is added as a hydroxyalkylating agent during step b) and additionally between step c) and e). The alkylene oxide can optionally be dispensed-in in a plurality of steps.

Propylene oxide is particularly preferably dispensed-in as an alkylene oxide.

The rate of addition of the hydroxyalkylating agent alkylene oxide takes place at reaction temperature. The rate of addition of the alkylene oxide is from 0.01 to 0.4 mol eq per minute. The rate of addition of the alkylene oxide is preferably from 0.02 to 0.2 mol eq per minute. The rate of addition of the alkylene oxide is particularly preferably from 0.04 to 0.1 per eq per minute.

Optionally, a plurality of alkylene oxides can be added sequentially or simultaneously or mixed. The rate of addition in this case relates to the sum of the alkylene oxides.

The reaction with the hydroxyalkylating agent and chloromethane takes place at from 60 to 110° C., preferably at 65 to 90° C., particularly preferably at 75 to 85° C.

Depending on the level of substitution sought, the quantity of hydroxyalkylating agent to be added is adjusted in a targeted manner. For the MHEC products currently in common use in various fields of application, the quantity of hydroxyalkylating agent to be used is around 0.02 to 5 eq per AGU, preferably around 0.05 to 1.0 eq per AGU, particularly preferably around 0.1 to 0.7 eq per AGU. This results in the production of MHECs having an MS (HE) of from 0.02 to 1.2, preferably having an MS (HE) of from 0.03 to 0.8 and particularly preferably having an MS (HE) of from 0.05 to 0.6.

MHPCs are preferably produced by the process according to the invention. For the MHPC products currently in common use in various fields of application, the quantity of PO to be used is around 0.05 to 5 eq per AGU, preferably around 0.5 to 4 eq per AGU, particularly preferably around 1.0 to 3 eq per AGU. This results in the production of MHPCs having an MS (HP) of from 0.05 to 3.3, preferably having an MS (HP) of from 0.2 to 1.8 and particularly preferably having an MS (HP) of from 0.4 to 1.2. The addition of the hydroxyalkylating agent to the reaction system can take place in one dispensing step or, portioned, in a plurality thereof.

In step e) the addition of chloromethane (MeCl II) takes place in at least the quantity which adjusts a hyperstoichiometric ratio of chloromethane (at least mol eq total NaOH+0.2) to total alkali metal hydroxide (total NaOH). The preferred quantity of MeCl II to be utilised adjusts a hyperstoichiometric ratio of total MeCl to total NaOH of mol eq total NaOH+0.4 to +4.0. The particularly preferred quantity of chloromethane to be utilised adjusts a hyperstoichiometric ratio of mol eq total NaOH+0.8 to +2.5.

Preferably, the molar quantity of MeCl II to be utilised corresponds to the molar quantity of total alkali metal hydroxide to be utilised, of mol eq total NaOH−1.2 to mol eq total NaOH+0.6. Preferably, the molar quantity of MeCl II to be utilised corresponds to the molar quantity of total alkali metal hydroxide to be utilised, of mol eq total NaOH−0.8 to mol eq total NaOH+0.2. The addition of the chloromethane takes place at reaction temperature.

No differentiation is consequently possible between the addition and the reaction phase. The addition of the chloromethane takes place at a temperature above 65° C., preferably at 75 to 90° C.

The chloromethane can be dispensed in the diluted state together with further suspending agent DME.

Optionally, the addition of further alkali metal hydroxide takes place in step f), with a hyperstoichiometric ratio of total utilised chloromethane to total utilised alkali metal hydroxide being maintained.

After the etherification has ended all the volatile constituents are separated out by distillation with optional application of partial vacuum. The volatile constituents are condensed and can be utilised as a suspension medium in the following batch.

The purification, drying and grinding of the resulting product takes place in accordance with the prior art methods which are conventional in cellulose derivative technology.

The Examples which follow are intended to elucidate the process according to the invention and describe the resulting products, without limiting the invention:

### EXAMPLES

In the Examples which follow the unit “eq” stands for the molar ratio of the respective substance to be utilised relative to the anhydroglucose unit (AGU) of the cellulose utilised.

### Examples 1 to 4

In an autoclave 0.5 parts by weight wood cellulose and 0.5 parts by weight cotton linters were inertised by evacuation and with nitrogen.

In step a) a mixture of dimethyl ether and chloromethane, consisting of approx. 40 wt. % chloromethane in relation to the total mass of the suspension medium, was then dispensed (introduced) into the reactor. A total of approx. 2.1 parts by weight of this suspension medium, in relation to the quantity of cellulose utilised, were dispensed. Sodium hydroxide in the form of a 50 wt. % aqueous caustic soda solution was sprayed on the cellulose, with mixing. Propylene oxide was then dispensed into the reactor in step b). The mixture was here heated to approx. 75° C.

In step c) at a reaction temperature of approx. 75° C. sodium hydroxide in the form of a 50 wt. % aqueous caustic soda solution was then dispensed. This brought about a change in stoichiometry (Examples 1 to 3).

Following this, further propylene oxide was dispensed into the reactor in step d) at a reaction temperature of 75° C.

The batch was then allowed to react for 70 min, with mixing.

In step e) chloromethane was then dispensed into the reactor within 20 minutes and simultaneously heated to approx. 85° C. reaction temperature. This brought about a renewed change in stoichiometry (Examples 1 to 3).

Sodium hydroxide in the form of a 50 wt. % aqueous caustic soda solution was subsequently dispensed in step f) at a reaction temperature of approx. 85°.

The batch was then reacted for a further 50 minutes at approx. 85° C.

The volatile constituents were distilled off, working partially under reduced pressure. The exhaust gas thus obtained was condensed and contained approx. 32 wt. % methyl chloride, in relation to the total mass. The exhaust gas could be used without further working-up steps as a suspension medium for the next reaction batch.

The raw product underwent washing with hot water, and was then dried and ground.

The quantities of etherifying agents to be utilised in the individual reaction steps are indicated in Table 1.

TABLE 1

| | Step a) | | Step b) | Step c) | Step d) | Step e) | Step f) | Comparison/ |
|---|---|---|---|---|---|---|---|---|
| Example | MeCl | NaOH I | PO | NaOH II | PO | MeCl | NaOH III | Invention |
| 1 | 2.7 | 2.3 | 1.5 | 0.6 | 1.5 | 4.2 | 2.1 | Invention |
| 2 | 2.7 | 1.7 | 1.5 | 1.2 | 1.5 | 4.2 | 2.1 | Invention |
| 3 | 2.7 | 1.7 | 1.5 | 1.2* | 1.5** | 4.2 | 2.1 | Invention |
| 4 | 2.7 | 1.7 | 1.5 | 0 | 1.5 | 4.2 | 3.3 | Comparison |

*addition of the NaOH took place in two partial steps each of 0.6 mol eq
**addition of the PO took place between the partial steps NaOH II

The rates of dispensing were 0.04 to 0.06 mol eq per minute for propylene oxide in step b) and d) as well as for sodium hydroxide in step c) and f).

The degree of substitution with methyl groups (DS-M), and the degree of substitution with hydroxypropyl groups (MS-HP) of the hydroxypropylmethyl cellulose ethers thus obtained are listed in Table 2. The viscosity (V2) in 2% aqueous solution (D=2.55 s⁻¹, 20° C., rotary viscometer) of the products was approx. 60,000 mPas. The NaCl content was <0.5 wt. % in all products.

TABLE 2

| | | | Comparison/ |
|---|---|---|---|
| Example | DS M | MS HP | Invention |
| 1 | 1.98 | 0.88 | Invention |
| 2 | 1.90 | 0.87 | Invention |
| 3 | 1.95 | 0.93 | Invention |
| 4 | 1.89 | 0.70 | Comparison |

Comparison Example 4 according to EP 1279680 has a markedly lower degree of substitution than the Examples in accordance with the process according to the invention. In particular, in Comparison Example 4 a powerful, and barely controllable, increase in temperature and pressure was recorded following step c), in particular in step d).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process of producing methylhydroxyalkyl cellulose (MHAC) comprising:
(a)
(i) introducing cellulose and a suspension medium into an autoclave, said suspension medium comprising 20 wt. % to 50 wt. % of chloromethane, based on the total weight of the said suspension medium, and
(ii) spraying the cellulose in said autoclave with an aqueous alkali metal hydroxide solution, thereby alkalizing the cellulose and reacting the cellulose with chloromethane;
(b) optionally introducing at least one hydroxyalkylating agent into said autoclave at a temperature above 60° C.;
(c) introducing alkali metal hydroxide into said autoclave in a hyperstoichiometric quantity of at least +0.1 mol eq., in relation to the chloromethane utilised;
(d) optionally introducing at least one hydroxyalkylating agent into said autoclave at a temperature above 60° C., and allowing the introduced hydroxyalkylating agent to react for at least 20 min;
(e) introducing chloromethane into said autoclave in a hyperstoichiometric quantity of at least +0.2 mol eq., in relation to the total alkali metal hydroxide utilised;
(f) optionally introducing alkali metal hydroxide into said autoclave, and allowing reaction to continue at a temperature of from 60° C. to 110° C.; and
(g)
(i) removing said suspension medium by distillation, thereby forming a distillate comprising residual chloromethane,
(ii) isolating the methylhydroxyalkyl cellulose, and
(iii) optionally washing, and drying the isolated methylhydroxyalkyl cellulose
wherein the hydroxyalkylating agent of step (d) is the same or different than the hydroxyalkylating agent of step (b), the alkali metal hydroxide is selected independently for each of steps (a), (c) and (f), and provided that addition of hydroxyalkylating agent occurs in at least one of step (b) and step (d).

2. The process of claim 1 wherein the methylhydroxyalkyl cellulose is selected from the group consisting of methylhydroxyethyl cellulose (MHEC), methylhydroxypropyl cellulose (MHPC) and combinations thereof.

3. The process of claim 1 wherein said suspension medium comprises dimethyl ether and 25 wt. % to 50 wt. % of chloromethane, based on the total weight of the suspension medium.

4. The process of claim 1 wherein in step (a) said suspension medium is introduced into said autoclave in an amount of 1.5 to 4.0 parts per part of cellulose.

5. The process of claim 1 wherein in step (c) the alkali metal hydroxide is a 35 to 60 wt. % aqueous solution of NaOH.

6. The process of claim 1 wherein the hyperstoichiometric quantity of alkali metal hydroxide of step (c) is between +0.1 and +4.5 mol eq., in relation to the chloromethane utilised.

7. The process of claim 1 wherein the hyperstoichiometric quantity of chloromethane of step (e) is between +0.4 and +4.0 mol eq., in relation to the total quantity of alkali metal hydroxide utilized.

8. The process of claim 1 wherein the total quantity of hydroxyalkylating agent of steps (b) and (d) is from 0.02 to 5 mol eq. per AGU of the cellulose.

9. The process of claim 1 wherein in step (c) and step (f) the alkali metal hydroxide is introduced into said autoclave at a rate of 0.01 to 0.4 mol eq. (per AGU of the cellulose) per minute.

10. The process of claim 1 wherein in step (b) and step (d) the hydroxyalkylating agent is introduced into said autoclave at a rate of from 0.01 to 0.4 mol eq. (per AGU of the cellulose) per minute.
